(19) United States
(12) Patent Application Publication
(10) Pub. No.: US 2017/0062200 A1
(43) Pub. Date: Mar. 2, 2017

(54) ELECTRODE FOR A SHORT-ARC HIGH PRESSURE LAMP

(71) Applicant: PHILIPS LIGHTING HOLDING B.V., Eindhoven (NL)

(72) Inventor: OLGA BORISOVNA MINAYEVA, BALDWIN PARK (US)

(21) Appl. No.: 15/120,118

(22) PCT Filed: Jan. 30, 2015
(86) PCT No.: PCT/IB2015/050697

§ 371 Date: Aug. 18, 2016

Related U.S. Application Data
(60) Provisional application No. 61/945,285, filed on Feb. 27, 2014.

(51) Int. Cl. H01J 61/073; H01J 9/04; H01J 61/86

(52) U.S. Cl. CPC H01J 61/0737; H01J 61/0732; H01J 61/86; H01J 9/04; G03B 21/2026

(57) ABSTRACT

An electrode (1) of a discharge device (e.g. the cathode of a discharge lamp) having a side area (4) and a tip area (5) implanted with an emissive material dopant induced by ion implantation is disclosed. The side area (4) of the electrode (1) may be masked (3) during ion implantation or a diffusion barrier layer (7) may be added on the side area (4) after ion implantation.

The present invention relates to an electrode for a short-arc lamp, in particular, to a cathode, made from a thoria free tungsten material, that has a layer of implanted emissive dopant near the surface of the tip of the cathode.

Conventional, short-arc lamps are a type of gas discharge lamp that produce electric light by passing electricity through ionized gas (e.g., xenon (Xe) or mercury vapor) at high pressure. The bright white light produced closely mimics natural sunlight. Xenon arc lamps, for example, are used in movie projectors in theaters, in searchlights, and for specialized uses in industry and research to simulate sunlight.

An arc region between anodes and cathodes of the short-arc lamps is so small that for many purposes, the short-arc lamps are effectively point sources. The anodes and the cathodes are generally made of tungsten. The cathode is small and pointed to ensure that its tip reaches a high temperature for efficient electron emission. The anode is more massive to withstand the electron bombardment and efficiently dissipate the heat produced.

In short-arc high pressure Xe lamps, the cathodes are generally made from a thoriated tungsten material. The thoriated tungsten material has exceptional characteristics (highest melting temperature of all oxides, Tₘₑₗₜ=3390° C., and low work function φ=2.5 eV) that make it ideal as an emissive dopant in such short-arc high pressure Xe lamps. However, one disadvantage of using thoriated tungsten (i.e., ThO₂ doped material) is that it is a radioactive material that emits α-particles.

Some attempts have been made to find a non-radioactive replacement for ThO₂ doped cathode material used in short arc high pressure lamps. For example, work has been done using 2%-doped NbO and SmO tungsten material for use in UV lamps. An alternative approach of reducing the Th concentration (instead of completely removing Th from the lamp) has also been attempted. For welding arcs, Th-free cathodes utilizing La₂O₃-doped, CeO₂-doped, Y₂O₃-doped tungsten, as well as various combinations of these three dopants in W, have also been used.

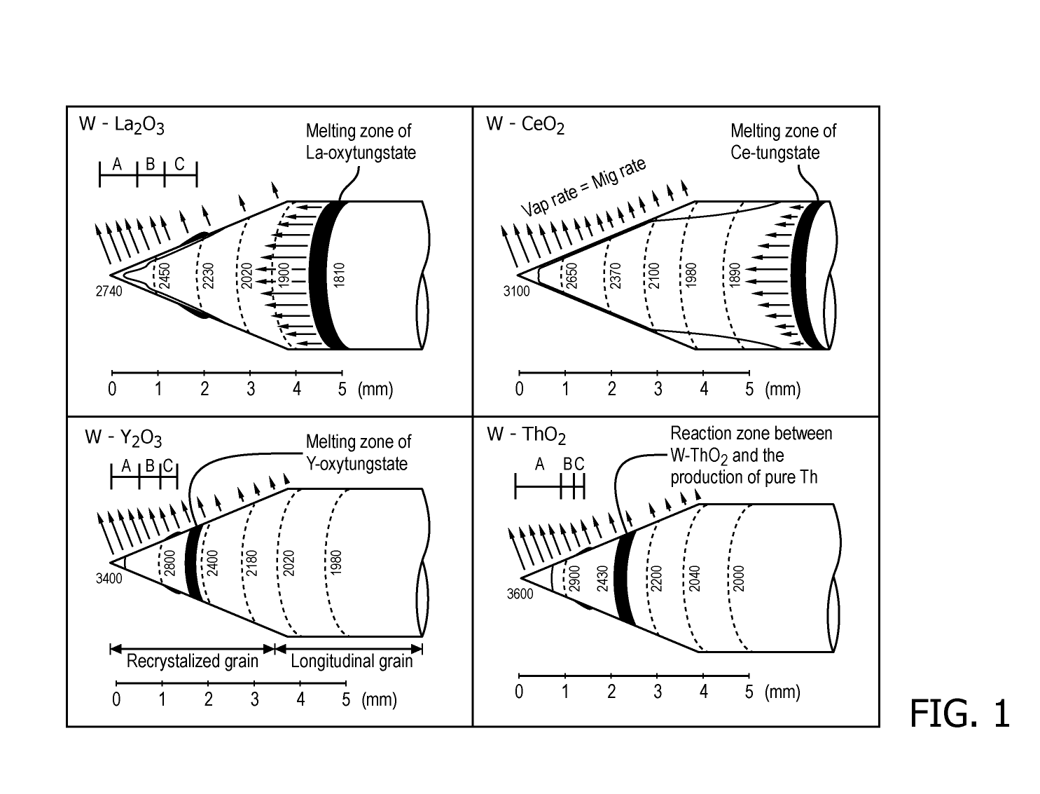

The mechanisms of cathode emission with these various dopants in the case of welding arcs is summarized in schematics shown in prior art FIG. 1. As shown in FIG. 1, the melting zones for both the La₂O₃ and the CeO₂ materials occurred at a cylindrical part of the cathode (5 mm or more away from the tip). In the case of the CeO₂ material, a large amount of the dopant was depleted from the sides of the cathode before reaching the cathode tip. In the case of the La₂O₃ material, there is a molten “pool” of emissive material formed near the tip of the cathode. That surface area covered with La₂O₃ could be beneficial for welding arcs, where diffuse plasma attachment to the cathode is desirable. However, in the case of short arc high pressure lamps, the constricted cathode spot arc attachment is necessary in order to create the point light source, which could be then efficiently focused by reflectors.

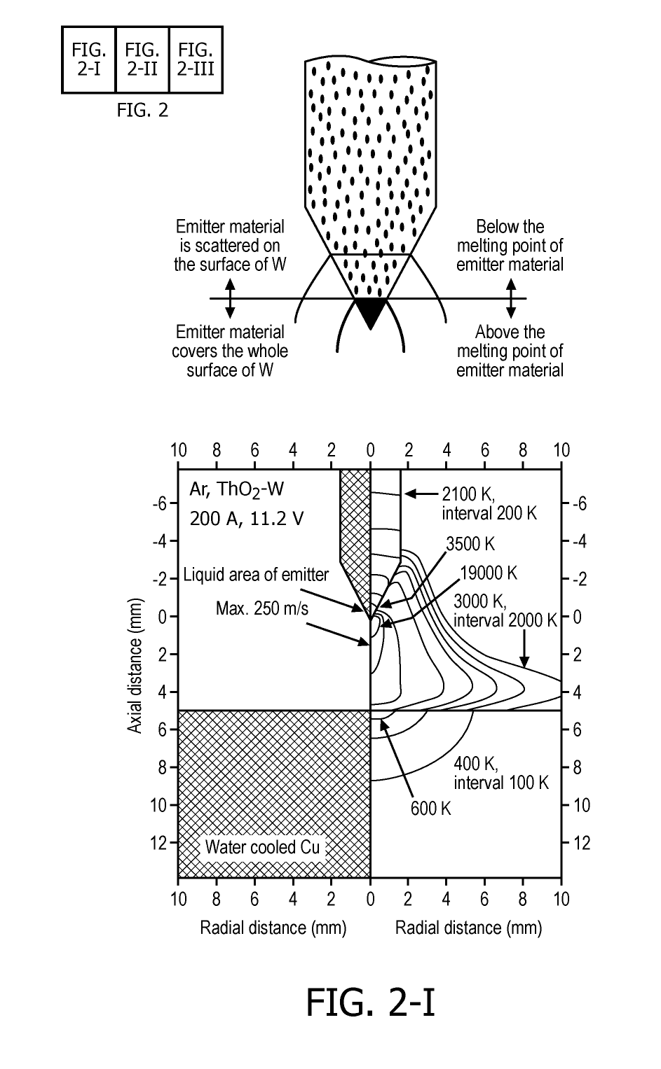

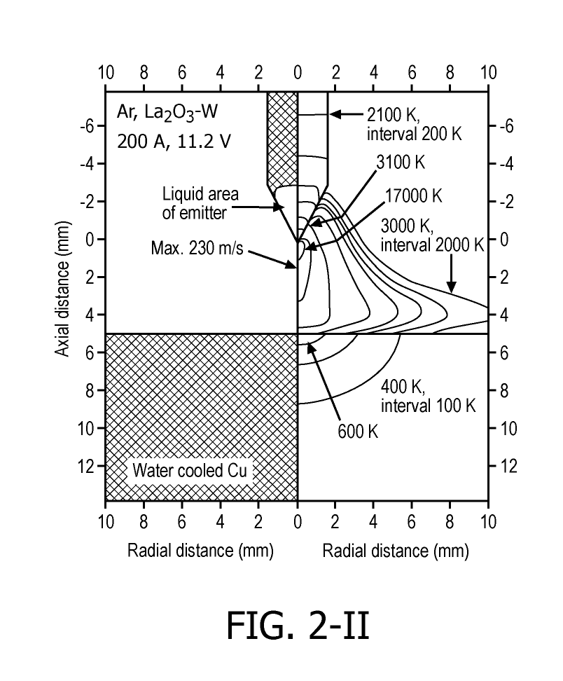

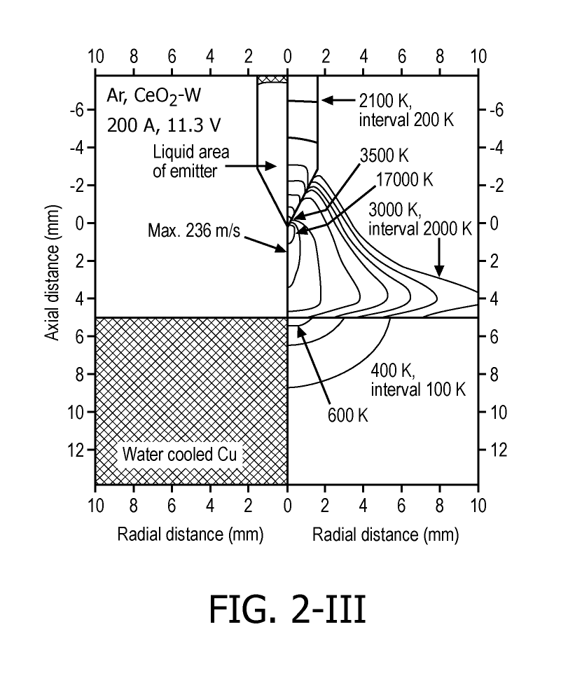

In this mechanism of arc attachment, the thoriated tungsten electrode has a maximum plasma temperature near the tip of 19000K, which is higher than 17000K obtained for La₂O₃ and CeO₂ doped electrodes. This is because the current attachment on the tip of ThO₂-doped cathode is constricted by the centralized location of liquid area of ThO₂ due to its higher melting point (as shown in prior art FIG. 2). Whereas for the La₂O₃ and the CeO₂ doped electrodes diffuse arc attachment is inevitable, reducing their usability for short arc lamps applications. It is noted that this statement is only true in case of uniformly distributed dopants in tungsten matrix, as also shown in FIG. 2.

The Y₂O₃-doped tungsten, as a dopant material for cathodes used in short-arc lamps, has a melting zone near the tip of the cathode that is similar to that of ThO₂-doped tungsten. However, the problem with the Y₂O₃-doped material is that it has “very low migration rate.” This means that the replenishment of the dopant at the tip of the cathode cannot happened fast enough, causing the tip to operate at higher temperature compare to ThO₂-doped tungsten (i.e., tip temperature of Y₂O₃-doped tungsten cathode is 4000K vs. 3600K for ThO₂-doped cathode). It should be understood by one skilled in the art that 4000K is higher than the tungsten melting point of 3695K, meaning that for conventional Y₂O₃-doped cathode the tip will melt, and diffusion of the emissive material will be further suppressed (diffusion mainly happens along the grain boundaries, melting results in rapid growth/fusion of the grains).

Accordingly, a need exists in the art for devices to address the shortcomings of the conventional electrodes described above.

One aspect of the present invention takes advantage of placing the Y₂O₃ material close to the tip of the cathode to help overcome this low migration rate limitation noted above.

Another aspect of the present invention takes advantage of the “low vaporization rate” of the Y₂O₃ material which makes this dopant and doping method feasible for cathodes of short arc Xe lamps.

Another aspect of the present invention is the use ion implantation for introducing an emissive material dopant near a cathode tip. Any of the following materials could be used as dopant material either alone or in combination with others: Y (or Y₂O₃), Ba (or BaO), Zr (or ZrO), La (or La₂O₃), Ce (or CeO₂). The substrate cathode material could be either pure tungsten or tungsten doped with low work function materials, such as La₂O₃, CeO₂, Y₂O₃, NbO, SmO, ZrO, BaO (or combination of them). In this regard, either traditional beam ion implantation or plasma induced ion implantation (PIII or PLAD) might be employed for fabricating the dopant layer under (and near) the tip surface.

One embodiment of the present invention is directed to a discharge lamp including an anode and a cathode. The cathode has a side area and a tip area having an emissive material dopant induced by ion implantation. The cathode is made from a material that does not include thoriated tungsten.

In another embodiment of the present invention is directed to an electrode for a discharge device prepared by a process including the steps of masking a side wall portion of the electrode but leaving a tip area of the electrode unmasked and implanting a tip area of the electrode with an emissive material dopant. The electrode is formed from a material that does not include thoriated tungsten.

Another embodiment of the present invention is directed to an electrode for a discharge device prepared by a process including the steps of implanting the electrode with an emissive material dopant using ion implantation and depositing a diffusion barrier on a side wall to cover a portion of the implanted electrode. The electrode is formed from a material that does not include thoriated tungsten.

In general, the various aspects and embodiments of the present invention may be combined and coupled in any way possible within the scope of the invention. The subject matter that is regarded as the invention is particularly pointed out and distinctly claimed in the claims at the conclusion of the specification.

The foregoing and other features and advantages of the invention will be apparent from the following detailed description taken in conjunction with the accompanying drawings.

FIG. 1 (prior art) show cathode schematics with various dopants.

FIG. 2 (prior art) show tips of ThO₂-doped cathodes constricted by the centralized location of liquid area of ThO₂ due to its higher melting point.

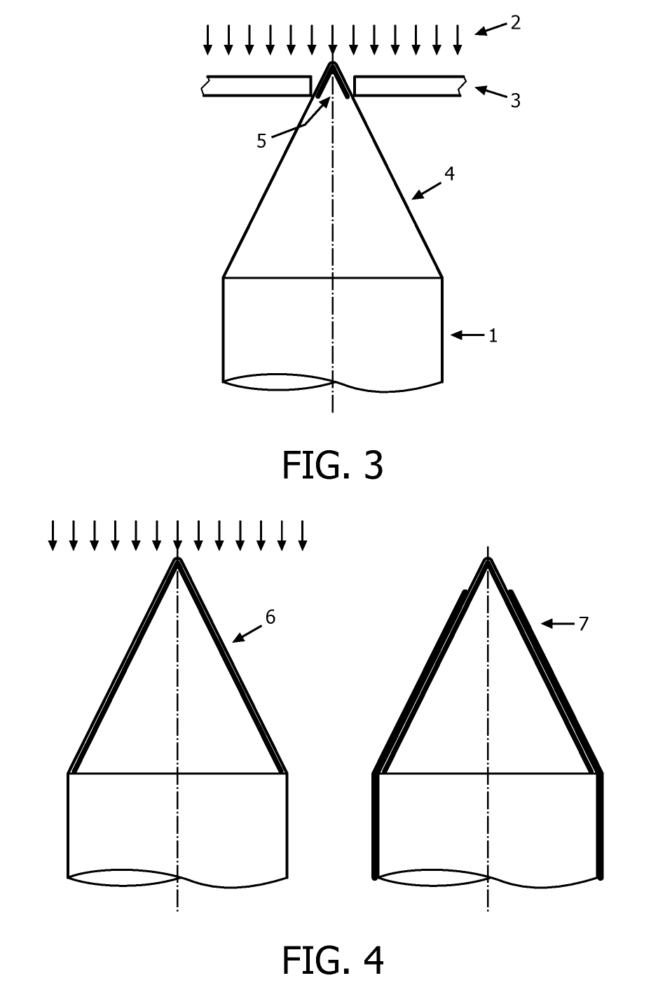

FIG. 3 show a cathode according to one embodiment of the present invention.

FIG. 4 show a cathode according to another embodiment of the present invention.

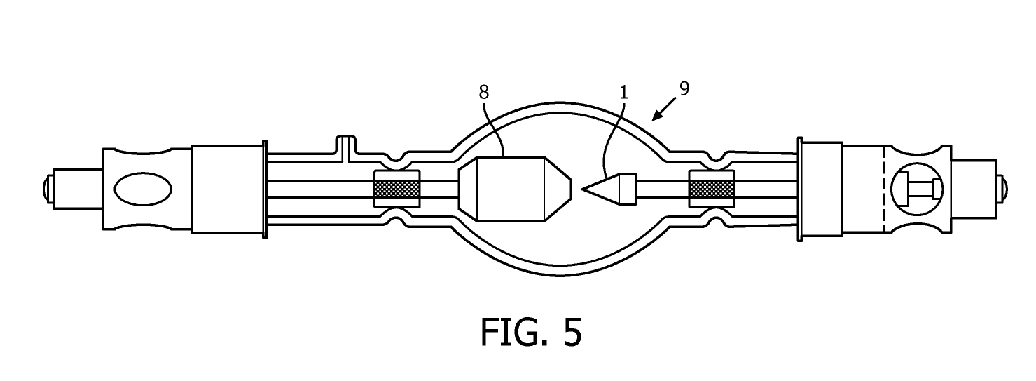

FIG. 5 shows a schematic of a short arc high pressure lamp according to an embodiment of the present invention.

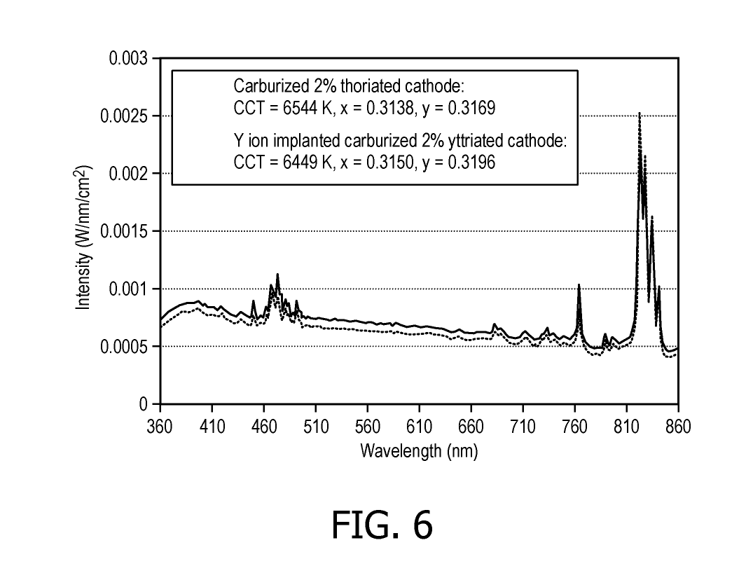

FIG. 6 show a comparison of spectral outputs of a cathode according to an embodiment of the present invention and a conventional cathode.

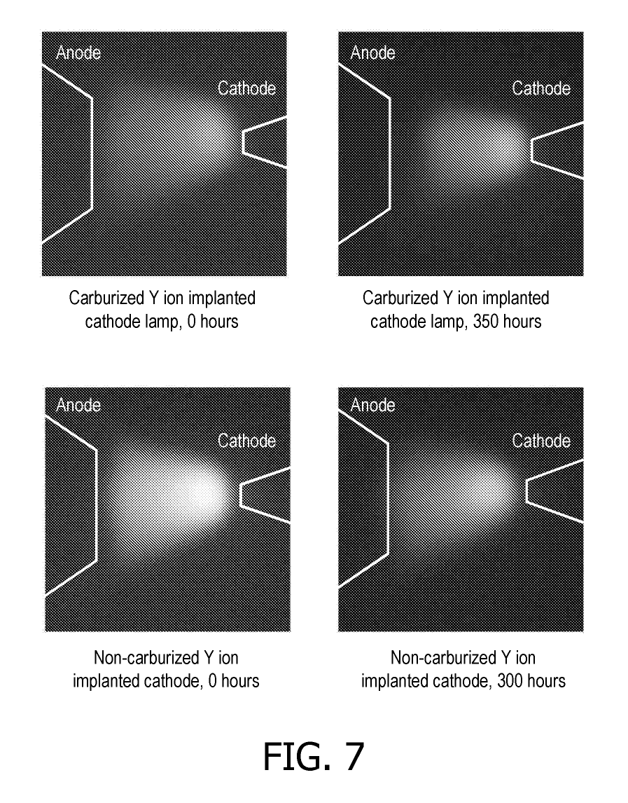

FIG. 7 shows arc attachments of two cathodes according to embodiments of the present invention.

For beam ion implantation, a penetration depth (d) of an implant is determined by mass of the ions and target (W) materials as well as by the energy of the beam, while the concentration of implanted dopants is determined by the dose (current and time) of the implantation. As shown in FIG. 3, since the ion implantation 2 is a line of sight surface treatment, the main area of interested is doping a tip area 5 of a cathode 1. Side areas 4 of the cathode 1 should be kept clear from excessive dopant to prevent arc attachment on the side areas 4. The side areas 4 of the cathode 1 may be masked 3 during ion implantation process as shown in FIG. 3.

Alternatively, FIG. 4 shows an ion implantation step 1 to implant an implanted profile 6 on the cathode 1. Step 1 is followed by deposition of a diffusion barrier 7 on the side areas 4 to cover a portion of the implanted profile 6. The diffusion barrier 7 could be made, for example, of tungsten carbide, tungsten nitrate, titanium nitrate, tantalum, tantalum carbide or comparable high melting temperature materials. Such high melting temperature materials have melting points above 4,000° F. (2,200° C.)). Alternatively, a layer of pure W deposited on top of implanted cathode 1 could also act as the diffusion barrier 7.

It is noted that the cathodes 1 shown in FIGS. 3 and 4 maybe, for example, short-arc high-pressure Xe lamps for digital cinema applications. FIG. 5 shows a schematic of a short arc high pressure lamp 9 for digital cinema applications. The lamp 9 includes the cathode 1 and an anode 8 arranged opposite to each other and enclosed in an envelope made of quartz. Gas inside is may be either Xe or Hg/Xe. Such lamps 9 operate at DC power between 1 kW and 10 kW.

In one embodiment, as noted above, the tip area 5 is doped by emissive material by means of ion implantation. The preferred emissive dopant is Yttrium (Y or Y₂O₃). The cathode 1 (substrate) material is 2%-Y₂O₃ doped W. The ion implantation is implemented, for example, by means of plasma induced ion implantation with ion energies in the order of 200 keV to a total dose of 1×10¹⁵ at/cm². This correspond to an additional atomic density of 3.6×10²² Y atoms/cm³ at the cathode surface. In order to keep the excess dopant introduced by ion implantation to the tip area 5 only a sample is carburized after ion implantation. The tip area 5 is generally defined as 1-2 mm below a point or tip of the cathode 1. The tip area 5 is left free of the diffusion barrier 7 (e.g., tungsten carbide) as shown in FIG. 4. The diffusion barrier 7 prevents Y loss from the side area 4 of the cathode 1. In addition, since carburization is done at elevated temperatures, this process helps expanding the depth of Yttrium implanted layer by diffusing Y into the cathode 1.

In another embodiment, vacuum carburization at 1750° C. for 30 min may be used. This process of vacuum carburization forms a W₂C layer with thickness in the range of ˜20-50 um on the cathode 1. A life test of lamps (e.g., as shown in FIG. 5) using the cathode 1 according to this embodiment was performed at rated (100%) power. Spectral characteristics of such lamps were measured every 20 hrs of life test at the point of maximum light intensity (i.e., arc spot). Images of arc attachments were also recorded every 20 hrs of operation.

Output characteristics of such lamps with screen lumens, ignition characteristics, and voltage variation levels (used to measure flicker in such lamps), all being compatible to thoriated cathode lamps, are shown in Table 1 below.

TABLE 1

| | Screen | Ignition | Flicker | Power, |
|---|---|---|---|---|
| Cathode type | Lumens | voltage | (Vₚₑₐₖ₋ₚₑₐₖ, V] | W |
| 2%-ThO₂ doped W | 18900-22000 | 25-35 kV | <1.2 V | 4000 |
| Carburized, Y | 19714 | 26.6 kV | 0.3 V | 4000 |
| ion implanted | | | | |
| 2%-Y₂O₃ doped W | | | | |
| Non-carburized, | 19049 | 29.8 kV | 0.3 V | 4000 |
| Y ion implanted | | | | |
| 2%-Y₂O₃ doped W | | | | |

Table 1 shows the initial light/electrical outputs for different cathode type lamps including a conventional thoriated cathode lamp (ThO₂ doped w) and two cathode type lamps according to embodiments of the present invention.

FIG. 6 show spectral outputs of Y ion implanted 2%-yttriated (carburized) cathode lamp as compared to a standard (conventional) (2%-thoriated, carburized cathode) lamp. As shown in FIG. 6, spectral characteristics of lamps according to embodiments of the present invention are similar to the conventional thoriated tungsten cathode lamps. It is noted that no Y peaks are observed on the spectrum, and color temperature (CCT) and color coordinates (x,y) are close to the standard (conventional) lamp values.

One characteristic of high-pressure short-arc lamps is to keep the arc attachment as close to a point source as possible throughout the operation. FIG. 7 shows the arc attachments of Y implanted carburized and non-carburized 2%-Y₂O₃ doped cathode according to embodiments of the present invention. FIG. 7 shows the start and end of life test for such cathodes 1. In this example, it is noted that the cathode arc attachment is a point source throughout the life test.

Table 2 shows a comparison among two embodiments of the present invention related to Y implanted Y₂O₃ cathode, carburized and non-carburized with other conventional Th-free cathode materials and conventional 2% thoriated W cathodes. As can be seen from Table 2, the lifetime of a Y implanted cathode lamp with carburized layer shows a 75% increase as compared to bare Y₂O₃-doped cathode (350 hrs vs. 200 hrs). This Y implanted cathode lamp with carburized layer also had a 70% of nominal lifetime as compared to the 2%-thoriated lamps. By varying the ion implantation parameters (dose and ion energy), the surface concentration of Yttrium and the depth of Yttriated layer near the surface, respectively, can be adjusted. This can further improve the lifetime performance of the cathodes 1.

TABLE 2

| | | | End of | |
|---|---|---|---|---|
| | | Last good | life | Reason for |
| Cathodes | Lamp type | test point | (EOL) | failure at EOL |
| 2% Y₂O₃, | 4000 W, digital | 6 hrs | 25 hrs | Failed to ignite |
| carburized | cinema projector | | | |
| 2% Y₂O₃, | 4000 W, digital | 200 hrs | 270 hrs | Lumens (50%), |
| non-carb | cinema projector | | | flicker |
| | | | | (3.2 Vₚₚ) |
| Y implanted | 4000 W, digital | 350 hrs | 360 hrs | Failed to ignite |
| Y₂O₃ cathode, | cinema projector | | | |
| carburized | | | | |
| Y implanted | 4000 W, digital | 326 hrs | 335 hrs | Failed to ignite, |
| Y₂O₃ cathode, | cinema projector | | | flicker |
| non-carburized | | | | |

| | | |
|---|---|---|
| 2% thoriated W | 4000 W, digital | Rated lifetime for 100% |
| cathodes | cinema projector | power test = 500 hrs |

In other embodiments of the present invention, emissive dopant materials can include, but not limited to, any of the following materials used alone or in combination with each other: Y (or Y₂O₃), Hf (or HfO), Ba (or BaO), Zr (or ZrO), La (or La₂O₃), Ce (or CeO₂).

In yet other embodiments of the present invention, bulk/substrate materials for the cathode 1 may be made of either pure tungsten or tungsten doped with the following materials: La₂O₃, CeO₂, Y₂O₃, NbO, SmO, ZrO, BaO.

In another embodiment of the present invention, any of the following techniques could be used to implant emissive dopants material (noted above) into the cathode substrate materials (note above): ion beam ion implantation, plasma induced ion implantation (PIII), plasma doping (PLAD), cluster ion implantation or ion beam mixing. Furthermore, it is noted that the minimum energy of the ion beam used by different techniques is 30 keV, and a minimum dose of 1×10¹² at/cm² is necessary for introducing sufficient amount of dopant material to the tip area 5 of the cathode 1.

In yet another embodiment of the present invention, the cathode 1 may have the diffusion barrier 7 (for example, WₓC, WN, TiN, Ta, TaC) formed on the sides of the cathode 1 to limit the release of implanted material on the sides 4 of the cathode 1 and prevent arc attachment expansion and/or movement. The diffusion barrier 7 can be deposited on the cathode 1 by means of CVD, PVD, PECVD, plasma spray or sintering. The minimum thickness of the diffusion barrier is in the order of 10 um.

In another embodiment of the present invention, the cathode 1 may have additional layer of W deposited on top of implanted layer by means of CVD, PVD, PECVD, plasma spray or sintering. This W layer could also serve as the diffusion barrier 7 to prevent arc attachment on the sides 4 of the cathode 1. Alternatively, the cathode 1 may be fabricated by means of ion implantation with using solid masking to prevent or minimize dopant implantation on the sides 4 of the cathode 1 and, hence, prevent/minimize arc attachment expansion and/or movement/flickering.

The various embodiments of the cathode 1 described above may be used in different short-arc high-pressure lamps, including, but not limited to: Xe and/or Xe/Hg lamps for digital cinema application, and ceramic Xe lamps.

The foregoing detailed description has set forth a few of the many forms that the invention can take. The above examples are merely illustrative of several possible embodiments of various aspects of the present invention, wherein equivalent alterations and/or modifications will occur to others skilled in the art upon reading and understanding of the present invention and the annexed drawings. In particular, regard to the various functions performed by the above described components, the terms (including a reference to a “means”) used to describe such components are intended to correspond, unless otherwise indicated to any component, such as hardware or combinations thereof, which performs the specified function of the described component (i.e., that is functionally equivalent), even though not structurally equivalent to the disclosed structure which performs the function in the illustrated implementations of the disclosure.

Although a particular feature of the present invention may have been illustrated and/or described with respect to only one of several implementations, such feature may be combined with one or more other features of the other implementations as may be desired and advantageous for any given or particular application. Furthermore, references to singular components or items are intended, unless otherwise specified, to encompass two or more such components or items. Also, to the extent that the terms “including”, “includes”, “having”, “has”, “with”, or variants thereof are used in the detailed description and/or in the claims, such terms are intended to be inclusive in a manner similar to the term “comprising”.

The present invention has been described with reference to the preferred embodiments. However, modifications and alterations will occur to others upon reading and understanding the preceding detailed description. It is intended that the present invention be construed as including all such modifications and alterations. It is only the claims, including all equivalents that are intended to define the scope of the present invention.

1. A discharge lamp comprising:
an anode; and
a cathode including a side area and a tip area having an emissive material dopant induced by ion implantation,
a diffusion barrier covering the side area, and
wherein said cathode is made from a material that does not include thoriated tungsten.

2. The discharge lamp according to claim 1, wherein the emissive material dopant, is one or more materials selected from the group including Y (or Y₂O₃), Ba (or BaO), Zr (or ZrO), La (or La₂O₃), or Ce (or CeO₂).

3. The discharge lamp according to claim 2, wherein the cathode substrate material is tungsten or tungsten doped with one or more of La₂O₃, CeO₂, Y₂O₃, NbO, SmO, ZrO, BaO.

4. The discharge lamp 44 according to claim 1, wherein the side area has less of or none of the emissive material dopant as compared to the tip area.

5. (canceled)

6. The discharge lamp according to claim 1, wherein the diffusion barrier
is formed from tungsten carbide, tungsten nitrate, titanium nitrate, tantalum, or tantalum carbide.

7. The discharge lamp 44 according to claim 1, wherein the tip area covers an area at least 1 mm below a tip of said cathode.

8. An electrode for a discharge device prepared by a process comprising the steps of:
masking a side wall portion of the electrode but leaving a tip area of the electrode unmasked; and
implanting a tip area of the electrode with an emissive material dopant,
wherein the electrode is formed from a material that does not include thoriated tungsten.

9. The electrode according to claim 8, wherein the emissive material dopant is one or more materials selected from the group including Y (or Y₂O₃), Ba (or BaO), Zr (or ZrO), La (or La₂O₃), or Ce (or CeO₂).

10. The electrode according to claim 8, wherein the electrode includes a substrate material that is tungsten or tungsten doped with one or more of La₂O₃, CeO₂, Y₂O₃, NbO, SmO, ZrO, BaO.

11. An electrode for a discharge device prepared by a process comprising the steps of:
Implanting the electrode with an em material dopant using ion implantation; and
depositing a diffusion barrier on a side wall to cover a portion of the implanted electrode,
wherein the electrode is formed from a material that does not include thoriated tungsten.

12. The electrode according to claim 11, wherein the emissive material dopant is one or more materials selected from the group including Y (or Y₂O₃), Ba (or BaO), Zr (or ZrO), La (or La₂O₃), or Ce (or CeO₂).

13. The electrode according to claim 11, wherein the electrode includes a substrate material that is tungsten or tungsten doped with one or more of La₂O₃, CeO₂, Y₂O₃, NbO, SmO, ZrO, BaO.

14. The electrode according to claim 11, where in the diffusion barrier is a layer of WxC, WN, TiN, Ta, or TaC.

15. The electrode according to claim 14, where in the diffusion barrier is at least 10 um thick.

16. The electrode according to claim 12, wherein the discharge device is a short-arc high-pressure lamp.
